(19) United States
(12) Patent Application Publication
(10) Pub. No.: US 2006/0217861 A1
(43) Pub. Date: Sep. 28, 2006

(54) Lane keeping assistant apparatus

(75) Inventors: Toru Ihara, Tokyo (JP); Keiichi Yamamoto, Tokyo (JP); Andreas Wingert, Baindt (DE)

Correspondence Address: ROSSI, KIMMS & McDOWELL LLP., P.O. BOX 826, ASHBURN, VA, 20146-0826, US

(73) Assignee: Mitsubishi Fuso Truck and Bus Corporation, Minato-ku (JP)

(21) Appl. No.: 11/388,779

(22) Filed: Mar. 24, 2006

(30) Foreign Application Priority Data
Mar. 25, 2005 (JP) 2005-88890

(51) Int. Cl. B62D 6/00

(52) U.S. Cl. 701/41; 701/300

(57) ABSTRACT

A lane keeping assistant apparatus alerts the driver when the vehicle deviates from the lane center, and aims at the driver's sure recognition of lateral deviation of the vehicle from the lane and concurrently at the avoidance of driver's overreliance on the apparatus. As a solution, the apparatus generates, on a steering wheel 1 of a vehicle, a pulse-like torque in a shape and, or frequency that does not affect the vehicle dynamics. Since such a frequency input can be haptically perceived by a human with ease, it is possible to make the driver notice the operation carried out by the apparatus without generating a yaw moment on the vehicle.

### BACKGROUND OF THE INVENTION

1. Field of the Invention

The present invention relates to a lane keeping assistant apparatus for informing the driver of his/her position relative to the lane center (alerting the driver if a vehicle is about to deviate from the lane).

2. Description of the Related Art

Conventionally, effort for study and development has been made on lane keeping assistant systems that obtain an image of the road ahead of the vehicle by means of a camera attached to the vehicle, calculating the vehicle position relative to lane center (“center of lane” on FIG. 9) , that is an amount of lateral deviation of the vehicle from the lane center using image processing for lane recognition, and finally assists steering to reduce the lateral deviation amount so that the vehicle can keep the lane. Such a lane keeping assistant system has been put into practice on some passenger vehicles. Now lane means an all area on the road practicable for vehicle which lines between white lines. Lane contains nearside lane and overtaking lane.

In such a lane keeping assistant system, the controller (ECU) contains maps (see FIG. 8) for determining an assist torque from the lateral deviation amount. The steering system mechanism of a vehicle is attached to an actuator (e.g., an electric motor) , which produces an assist torque determined with reference to the above maps whereupon the driver's steering operation is assisted.

For example, characteristic of maps a-d in FIG. 8 are known to the art as those for assist-torque determination, These characteristics (map shapes) are appropriately determined by each manufacturer; the upper torque limit (maximum torque) and conditions for steering assist cancellation and the like are determined so as not to interfere with the driver's steering operation in an emergency and so as not to deviate from the original usage (i.e., so as not to serve as an automatic driving system).

Besides the technique for assisting the steering operation to maintain the vehicle at the lane center, there is a technique for alerting the driver with a vibrating steering wheel when the vehicle leaves the lane (disclosed in, for example, Japanese Patent Application Publication No. 2000-251171).

Besides, there is provided a technique that measures the degree of decrease in the driver's alertness on the basis of information including a vehicle speed, steering wheel angle, accelerator depression amount, brake pedal on-off state, cultch operation state, transmission shift position, and flasher lever operation state, and then alerts the driver in accordance with the measured alertness decrease degree (e.g., disclosure in Japanese Patent Application Publication No. HEI 7-290990).

Such conventional lane keeping assistant systems assume vehicles traveling on expressways, which are generally large in radius of curvature, so that an assist torque applied by each lane keeping assistant systems is consequentially a low frequency input (i.e., a gradual steering operation).

As a consequence, corrective torque from a lane keeping assistant system is provided to the steering wheel also at low frequencies. However such a low-frequency corrective steering input might not be perceived by the driver. Therefore the driver might be unaware of the operation of the system. This is especially the case, if the vehicle is close to the lane center, where the corrective steering torque is low. This is problematic if the driver becomes unaware of the steering operations required for maintaining the vehicle in the lane, and starts relying on the system. Also, lane deviation due to lack of alertness usually occurs slowly (i.e., at low frequencies) and therefore corrective steering torque of the lane keeping assistant system is input at low frequencies. Snaking as a result of low driver attention is partially reduced by the system. However, the driver again might not be aware of the operation of the system and might not recognize his reduced level of attention.

The magnitude of a stimulus and the magnitude of the sensation perceived by a human are not a proportional relationship. A common way to model this relationship is to use Steven's Power, expressed by the following formula:).
S=aI^{b} (1)
where, S is sensation magnitude, I is a stimulus intensity, and a and b are constants.

To solve this problem, it is supposable to increase the assist torque to levels that are clearly perceivable by the driver, and in turn informing the driver of the operation of the system. But this method contains following problem. In accordance with this power low, a stimulus intensity must be increased exponentially to increase a sensation magnitude in a proportional. This means that the assist torque must be increased like an exponential function in order to increase a sensation for the activation of the system.

Such an approach is not feasible, as the maximum assist torque must be limited as not to interfere with the steering in emergency situations as described above.

Further, supposing that an assist torque is used that is large enough to be perceived by the driver, the system plays a role similar to an automatic steering system, which carries out the steering operations to some extent without driver's application of steering force, and there is the possibility that the driver overrelies on the system and that the driver leaves the system to steer.

### SUMMARY OF THE INVENTION

With the foregoing problems in mind, the object of the present invention is to provide a lane keeping assistant apparatus that can surely make the driver recognize lateral deviation of the vehicle from the lane center but not cause the driver to over-rely on the apparatus.

To attain the objective, there is provided a lane-keeping assistant apparatus of the present invention comprising torque generating means for generating a torque in form of pulses in a shape and at a frequency that does not significantly affect the steering of the vehicle. The meaning of “does not affect the vehicle dynamics” contains the meaning “affect the vehicle dynamics is small as can pay no mind or can be acceptable”. It must be same meaning at all claims in this application.

As another feature, a lane keeping assistant apparatus of the present invention comprising: lane center locating means for locating the center of a lane on which a vehicle is traveling; lateral deviation amount calculating means for calculating an amount of lateral deviation of a width center of the vehicle from the center of the lane located by the lane center locating means; torque generating means for generating a torque that is to be applied to the steering wheel of the vehicle based on the lateral deviation amount calculated by the lateral deviation amount calculating means and for pulsewise generating a torque in form of pulses, in a shape and at a frequency that does not significantly affect the steering of the vehicle.

With the lane keeping assistant apparatus of the present invention, the driver can sense the operation of the assistant apparatus even at a region with a minute lateral deviation amount and at the same time the assistant apparatus extremely suppresses effects of the assist torque on the steering of the vehicle. Advantageously, the assistant apparatus can surely make the driver notice lateral deviation of the vehicle from the lane, if any, and at the same time. can avoid driver's overreliance on the assistant system.

As a preferable feature, the torque generating means may generate a pulse-like torque that increases in magnitude as the lateral deviation amount becomes larger. As another preferable feature, the torque generating means may generate the pulse-like torque at shorter time intervals as the lateral deviation amount becomes larger.

With such a configuration, it is advantagously possible for the driver to sense the extent and direction of lateral deviation and to be encouraged to an appropriate steering operation.

As an additional preferable feature, the torque generating means may generate a pulse-like torque in a direction that the width center of the vehicle is closing to the center of the lane and then may generate the torque that is to be pulsewise generated in a direction that the width center of the vehicle is departing from the center of the lane.

Inversion of the direction of a torque to be pulsewise generated can impressively appeal lateral deviation of the vehicle to the driver. Further, the movement on the vehicle by the influence of the assist torque can surely be controlled.

As a further preferable feature, the lane keeping assistant apparatus may further comprise alertness measuring means for measuring alertness of a driver of the vehicle, and the torque generating means may generate a pulse-like torque with a magnitude that increases as the alertness of the driver measured by the alertness measuring means decreases. As still a further preferable feature, the torque generating means may generate the pulse-like torque at shorter time intervals as the alertness of the driver measured by the alertness measuring means decreases.

In these cases, the magnitude and frequency of the pulse-like torque input vary in accordance with the amount of decrease in alertness of the driver, so that it is possible to certainly induce the driver's alertness and to provide the driver with lane position information suitable for the current alertness level.

As still a further preferable feature, the torque generating means may generate the pulse-like torque repeatedly at shorter time intervals as the vehicle is traveling at a higher speed.

With this feature, since a time interval for pulsewise generation of torque is shortened when the vehicle travels at a high speed, it is possible to cause the driver to intensively recognize the lane position information at high-speed driving so that the driver can properly steer to keep the lane.

As still further feature, the frequency may be equal to or higher than 3 Hz, which surely appeals driver's sensation without affecting the vehicle dynamics.

Other objects and further features of the present invention will be apparent from the following detailed description when read in conjunction with the accompanying drawings.

### BRIEF DESCRIPTION OF THE DRAWINGS

FIG. 1 is a block diagram schematically showing a main part of a lane keeping assistant apparatus of the present invention;

FIG. 2 is a schematic structure illustrating a steering mechanism of a vehicle to which the present invention is applied;

FIG. 3 is a graph showing torque maps used in the lane keeping assistant apparatus according to the present invention;

FIG. 4 is a graph showing gain maps used in the lane keeping assistant apparatus according to the present invention;

FIG. 5 is a graph showing an example of a three-dimensional map used in the lane keeping assistant apparatus according to the present invention;

FIG. 6 is a graph showing a general steering characteristic for explaining reasons for basis for determination steering input frequencies;

FIG. 7 is a block diagram schematically showing the lane keeping assistant apparatus of the present invention;

FIG. 8 is a graph showing a torque map used in a conventional lane keeping assistant system; and

FIG. 9 is a graph showing an example of lanes and lines on a road where the vehicle travels.

### DESCRIPTION OF THE PREFERRED EMBODIMENTS

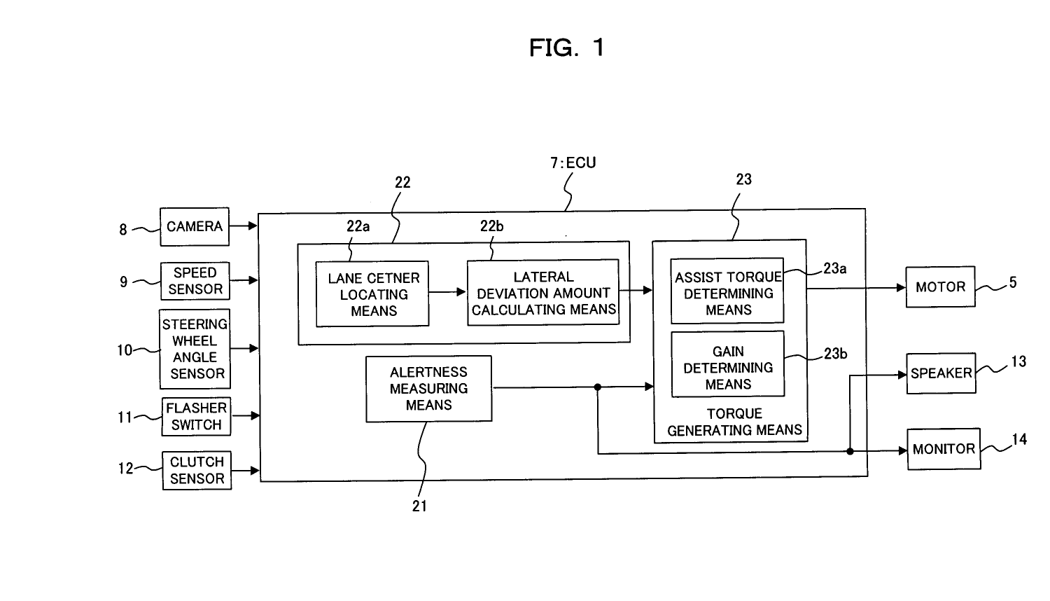

A preferred embodiment of a lane keeping assistant apparatus of the present invention will now be described with reference to the accompanying drawings FIGS. 1-7.

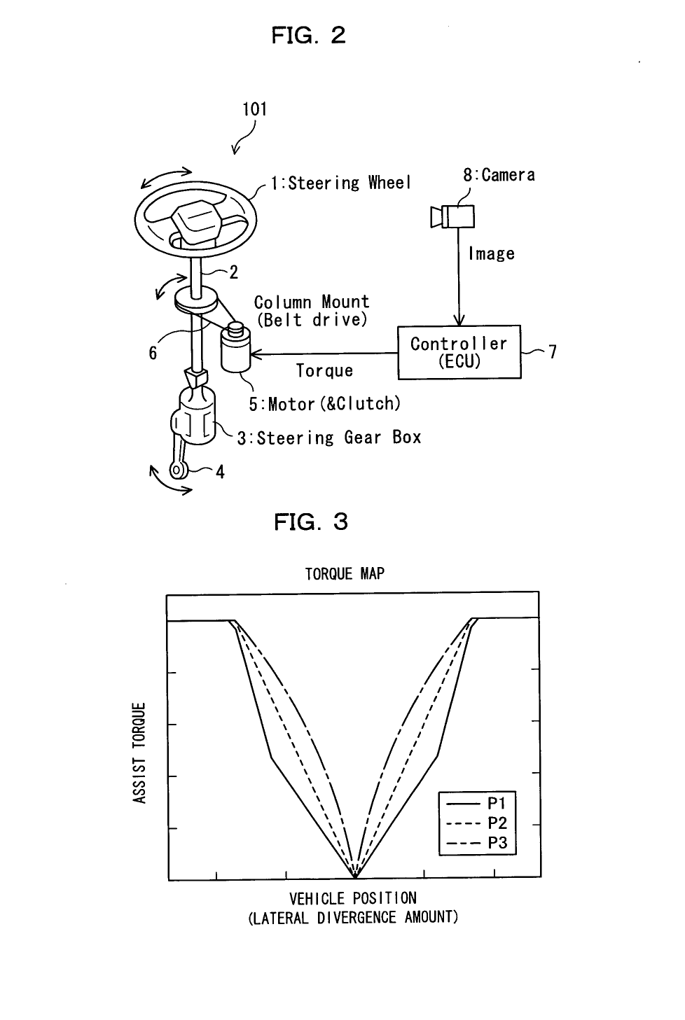

As shown in FIG. 2, the steering mechanism 101 of a vehicle includes a steering wheel 1, a steering shaft 2, a steering gear box 3, a pitman arm 4, a motor (a power source) 5 and the like.

The steering wheel 1 is engaged with the steering gear box 3, which is engaged with the pitman arm 4, via the steering shaft 2. The pitman arm 4 is engaged with non-illustrated front wheels via linking mechanisms also not illustrated. Rotation of the steering wheel 1 swings and drives the pitman arm 4 and thereby steers the front wheels.

The steering shaft 2 is engaged with the motor 5 via a belt 6. Driving torque that the motor 5 generates assists steering inputs from the steering wheel 1. The motor 5 attaches to a clutch mechanism, which is however not illustrated in detail, for interruption of engagement between the motor 5 and the steering shaft 2.

As shown in FIGS. 1 and 2, the motor 5 is connected to a controller (ECU, electronic control unit) 7 serving as controlling means. A state of operation of the motor 5 is controlled on the basis of control signals issued from the ECU 7.

Further as shown in FIG. 1, to the ECU 7 is connected a camera 8 that is fixed to a non-illustrated position suitable for acquiring an image of the forward of the vehicle, a speed sensor 9 for measuring the traveling speed of the vehicle, a steering angle sensor 10 for measuring a steering angle of the steering wheel 1, a flasher switch 11 for detecting operation states of left and right flasher, and a clutch sensor 12 for detecting an operation state of the clutch. Additionally, however not illustrated, an accelerator opening sensor for measuring the amount of accelerator opening or the amount of depression of the accelerator, a brake sensor for detecting an on-off state of a brake pedal, and a sensor for obtaining a shift position of the transmission are connected to the ECU 7. Various states or information concerning the vehicle dynamics detected by theses sensors are sent to the ECU 7.

Here, the ECU 7 calculates, on the basis of image information acquired by means of the camera 8, an amount of lateral deviation of a width center of the vehicle from the center of the lane on which the vehicle is traveling (a vehicle position relative to lane center) and at the same time measures, on the basis of information from each sensor, a degree of decrease in alertness of the driver. Further, judging from the calculated lateral deviation amount and the measured alertness decrease degree, the ECU 7 determines parameters of the magnitude of an assist torque (a driving torque of the motor 5) that is to be applied to the steering wheel 1, a frequency (a steering input frequency is to be applied to the steering wheel 1) and the like to perform feedback control on the steering wheel 1.

An assist torque that is to be applied to the steering wheel 1 is a pulse-like torque with a pulse-width and duty-cycle low enough not to significantly affect the steering of the vehicle hardly (possible to disregard or allow the vehicle dynamics. An assist torque having a frequency thus determined causes the lane keeping assistant apparatus not to serve as automatic steering system, and haptic feeling from the steering wheel 1 can make the driver sense the operation of the lane keeping assistant apparatus.

As described above, the lane keeping assistant apparatus of the present invention performs control that affects perception and sense of touch of the driver (that haptically affects the driver) , so that the feedback control performed by the apparatus of the present invention can be referred as haptic feedback control. In the illustrated example, steering input frequency is specified to equal to or higher than 3 Hz (i.e., a cycle equal to or shorter than 0.33 second) and the reason for this specification will be described later.

Hereinafter, description will be made in relation to a functional configuration of the ECU 7. Inside the ECU 7, there are disposed alertness measuring means 21 for measuring or estimating alertness of the driver, lane deviation monitoring means 22 for determining direction and magnitude of lane-center diviation, and torque generating means 23 for generating a pulse-like torque on the steering wheel 1 of the vehicle on the basis of information obtained by the alertness measuring means 21 and the lane deviation monitoring means 22.

The alertness measuring means 21 estimates alertness of the driver based on road image of the forward of the vehicle acquired by the camera 8 and information obtained by the above sensors. For example, if position data of continuous or broken lines, representing the lane boundary, in road information from the camera 8 and operation data of the steering wheel 1 obtained by the steering angle sensor 10 judge meandering of the vehicle in the alertness measuring means 21, the alertness measuring means 21 further determines whether or not the meandering is caused by low alertness on the basis of flasher operation data obtained by the flasher switch 11 and determines a degree of decrease in alertness on the basis of the amount of the snaking. In accordance with the determined degree of decrease in alertness, the alertness measuring means 21 alerts the driver by means of an alarm from a speaker 13 or warning display on a monitor 14, and notifies the pulse generating means 23 of the determined degree of alertness decrease of the driver.

The lane deviation monitoring means 22 determines the amount and direction of lane-center deviation based on the image information ahead of the vehicle acquired by the camera 8, and includes lane center locating means 22a and lateral deviation amount calculating means 22b.

The lane center locating means 22a is used for locating the center of the lane on which the vehicle in question is traveling. Specifically, the lane center locating means 22a recognizes continuous or broken lines on both sides of the vehicle based on the road image obtained by image processing performed on information from the camera 8, determines the division between the recognized continuous or broken lines of the lane on which the vehicle is traveling, and locates the center of the determined lane. The lateral deviation amount calculating means 22b calculates a distance between the width center of the vehicle and the center of the lane located by the lane center locating means 22a, which distance serves as an amount of lateral deviation. methods for alertness estimation in the alertness measuring means 21, center location in the lane center locating means 22a, and lateral deviation amount calculation in the lateral deviation amount calculating means 22b are known to the public, so detailed explanation will be omitted here.

The pulse generating means 23 includes assist torque determining means 23a for driving the motor 5 and determining an assist torque that is to be generated on the steering wheel 1, and gain determining means 23b for determining a gain, a steering input frequency (a period) and time intervals at which a pulse is to be generated concerning the assist torque determined in the assist torque determining means 23a.

The assist torque determining means 23a retains a map shown in FIG. 3, and determines an assist torque corresponding to an deviation amount calculated by the lateral deviation amount calculating means 22b.

The assist torque determining means 23a of this embodiment retains three maps P1, P2 and P3 different in characteristic, as shown in the drawing. The degree of alertness decrease measured in the alertness measuring means 21 selects suitable one from the three maps.

Additionally, as the degree of decrease in alertness of the driver becomes larger (i.e., as the alertness of the driver becomes less) , a greater assist torque is determined. Specifically, the assist torque determining means 23a selects a map in the order of P1, P2 and P3 as the degree of decrease in alertness of the driver becomes larger.

This embodiment has three characteristics in the assist torque determining means 23a. Alternatively, one, two or more than three characteristics may be used for determination of an assist torque.

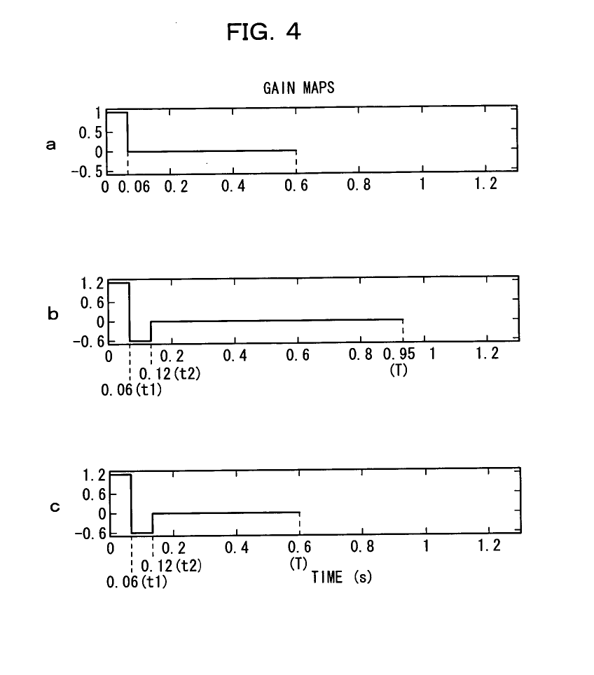

As shown in FIG. 4, the gain determining means 23b retains three maps each representing a combination of a time period (width “t” of pulse) for an output of an assist torque caused by rectangular pulse wave and time intervals “T” at which a pulse is to be repeatedly generated. On the basis of the state of movement, e.g., vehicle speed, the degree of decrease in alertness of the driver, the lateral deviation amount and other factors, one from the three maps is selected.

Each of maps a through c refers to pulsewise generation of an assist torque having a pulse width t which is equal to or shorter than 0.33 second.

Specifically, map a represents characteristic of an assist torque having a gain of +1.0, a pulse width t of 0.06 second and being repeatedly generated at time intervals T of 0.60 seconds. Here, a gain is a coefficient related with an assist torque determined by the assist torque determining means 23a: a positive gain generates the assist torque in a direction that the width center of the vehicle is closing to the center of the lane; and a negative gain generates the torque in a direction that the width center of the vehicle is departing from the center of the lane. Accurately, map a contains all frequencies because the shape of the wave on map a is rectangular. But it can be approximated as a sine wave (positive half-wave). In this case, the period of map a is 0.12 seconds (twice t) so the frequency of map a is about 8.3 Hz.

When map a is selected, an assist torque determined by the assist torque determining means 23a is input into the steering wheel 1 for t=0.06 second and this input is repeated at time intervals of T=0.60 second. Such generation of high frequency (about 8.3 Hz) inputs on the steering wheel 1 enables the driver to tactilely feel the input of the assist torque through the hands which grops the steering wheel 1 so that the driver notices the activation of the apparatus.

Each of maps b and c represents characteristic of an assist torque having a gain of +1.2 during the pulse 0.06 seconds of 0.12 second period (t1) and a gain of −0.6 during the latter half 0.06 second (t2) . Namely, both map b and map c respectively represent an assist torque generated in a direction that the width center of the vehicle is closing to the center of the lane and then in a direction that the width center of the vehicle is departing from the center of the lane. Map b and c are featured by torque generation repeated at time intervals “T” of 0.95 second and 0.60 seconds, respectively.

Assist torques generated in accordance with maps b and c an appeal to the perception of the driver more strongly than the torque generated in accordance with map a because of a stronger initial assist torque followed by quick temporary reversal of the assist torque. To achieve a given level of perception, maps b and c more strongly suppress the effect on vehicle dynamic for the following reason.

With map a, the torque input rotates the steering wheel by a very small angle, which is perceivable by the driver, but not big enough to affect the dynamics of the vehicle. The elasticity in the driver's hands touching the sterring wheel and the elasticity of the steering system will cause the steering wheel to partially return. A full return to the initial steering angle after the torque input is prevented by the friction in the steering system. The torque reversal in maps b and c helps to overcome to this friction and to return the steering wheel closer to its initial angle. Despite this reversal in direction, the driver can clearly perceived the intended direction of the assist torque.

The gain determining means 23b is determined so as to select a map having a larger variation in assist torque as the measured alertness is lessening. In this embodiment, since the variation in assist torque become larger in an order of map a, map b, map c, enlargement of a degree of decrease in alertness selects one in the above order of map a, map b, and map c.

In the illustrated example, the gain determining means 23bretains three maps; as an alternative, the gain determining means 23b may have a single map or an arbitrary number of maps.

Characteristic of a map determined in the gain determining means 23b should by no means be limited to those of the above three example maps and various changes and modifications can be suggested. For example, a plurality of maps having at least respective different gains maybe prepared and a map may be sequentially selected in such a manner that a gain concerning a plus-like torque become larger in accordance with an increase in the lateral deviation amount calculated by the lateral deviation amount calculating means 22b. Alternatively, less alertness of the driver measured by the alertness measuring means 21 may sequentially select a map representing a larger gain. It does not limited to a rectangular pulse-wave, and for example, very sharp sine waves and triangular waves are possible.

Further alternatively, a plurality of maps for assist torques that are to be generated at least at respective different time intervals “T” may be prepared and one from the plurality of map may be sequentially selected such that a larger lateral deviation results in an assist torque generated at shorter time intervals. Likewise, as the driver reduces alertness, a suitable map with assist torque generated at shorter time intervals may be selected. Still further, a map may be suitably selected from the plurality of maps so as to generate an assist torque at shorter time intervals as the vehicle is traveling at a higher speed.

The configuration of the pulse generating means 23 has been described as above, and the operation thereof is hereinafter described. For example, assuming that the assist torque determining means 23a selects map P1 to determine an assist torque and the gain determining means 23b selects map a, first of all the assist torque determining means 23a determines an assist torque in accordance with the vehicle position (the lateral deviation amount) with reference to map P1 and then the gain determining means 23b multiplies the assist torque determined by the assist torque determining means 23a by the gain (+1.0, here) of map a to determine an assist torque that is to be finally output and determines also a generation pattern of the final output torque. Namely, in this example, in accordance with map a, an assist torque is determined to be generated at a period of 0.06 second at time intervals of 0.60 seconds.

If a vehicle is about be deviate from the lane without turning a flasher on, the lane deviation monitoring means 22 and the pulse generating means 23 determine a pulse-like torque (an assist torque) that is to be generated on the steering wheel 1 in accordance with the lateral deviation amount from the lane center and outputs the assist torque at predetermined time intervals.

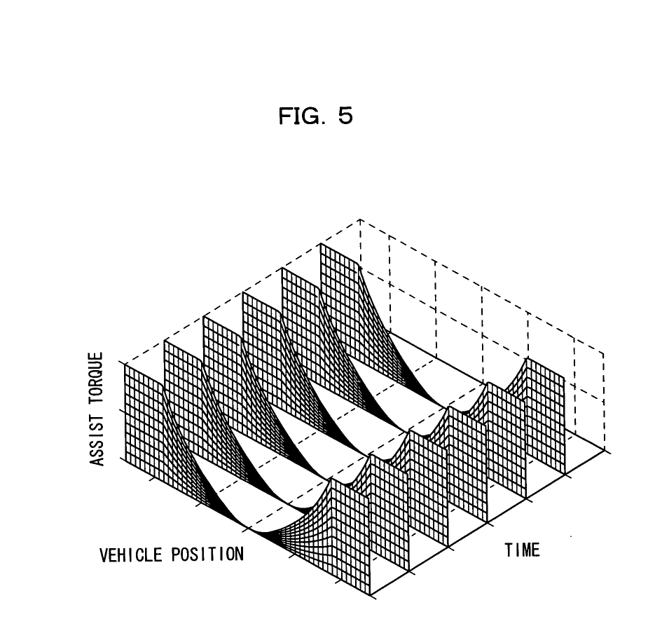

A composition of two maps retained in the assist torque determining means 23a and the gain determining means 23b forms a three-dimensional map shown in FIG. 5. Here, the three-dimensional map shown in FIG. 5 is an example of a composed map of map P1 and map a selected by the assist torque determining means 23a and the gain determining means 23b, respectively. The pulse generating means 23 may retain such a three-dimensional map from the beginning and may determine a magnitude and a steering input frequency of an assist torque that is to be generated on the steering wheel. Alternatively, the pulse generating means 23 may retain a plurality of three-dimensional maps and may select one of the maps in accordance with a degree of decrease in driver alertness and a movement state of the vehicle.

Hereinafter, description is made in relation to reasons for a short period (equal to or shorter than 0.33 second, a high frequency input equal to or higher than 3 Hz) of a pulse-like torque determined by the pulse generating means 23.

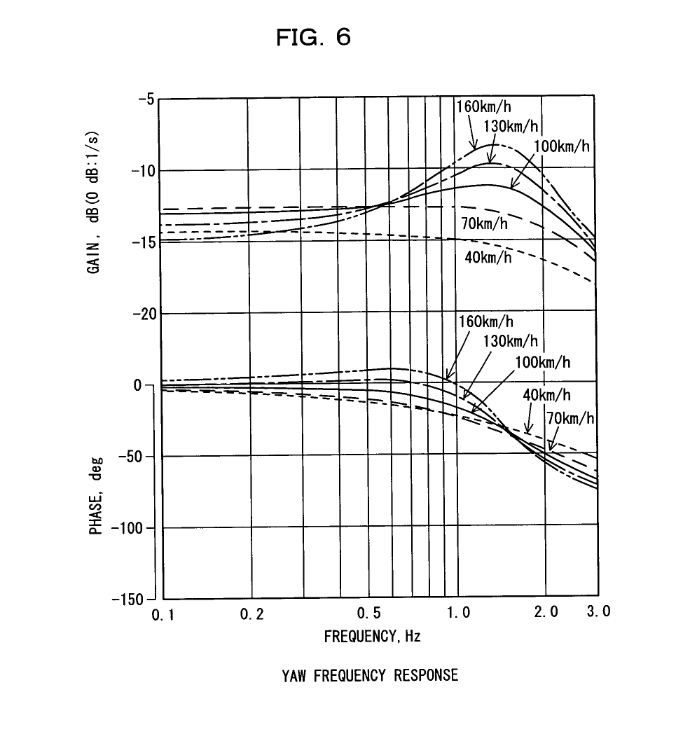

FIG. 6 is a graph showing general characteristics of steering and yaw frequency responses of a vehicle. As shown in the graph, yaw frequency responses against the steering angle of a vehicle approximate a second order low pass filter response; a steering input at a frequency higher than that peaks a responsive gain (peak frequency, in this case, approximately 1.5 to 2.0 Hz) has a large response delay (and therefore has low responsibility) and decreases remarkably at the frequency. Conversely, a low frequency region equal to or lower than 1.0 Hz has little delay (and therefore high responsibility) and does not decrease remarkably in the low frequency region.

For this reason, pulsewise application of high speed steering input (equal to or higher than 3 Hz, i.e., steering period equal to or shorter than 0.33 second) does not affect vehicle dynamics (in other words, generates no yaw moment on the vehicle) and concurrently makes it possible to alert the driver to deviations from the lane via the steering wheel 1. Particularly and advantageously, since such a high frequency in put can be easily perceived (Stevens's Power Law) an assist torque that is small in magnitude but is high in frequency can cause the driver to recognize lateral deviation of the vehicle. When the assist torque is rectangular pulse, the above-mentioned characteristic can be obtained by considering the pulse-wave to be a half wave of the sine wave, and setting the pulse width to 0.17 seconds or less.

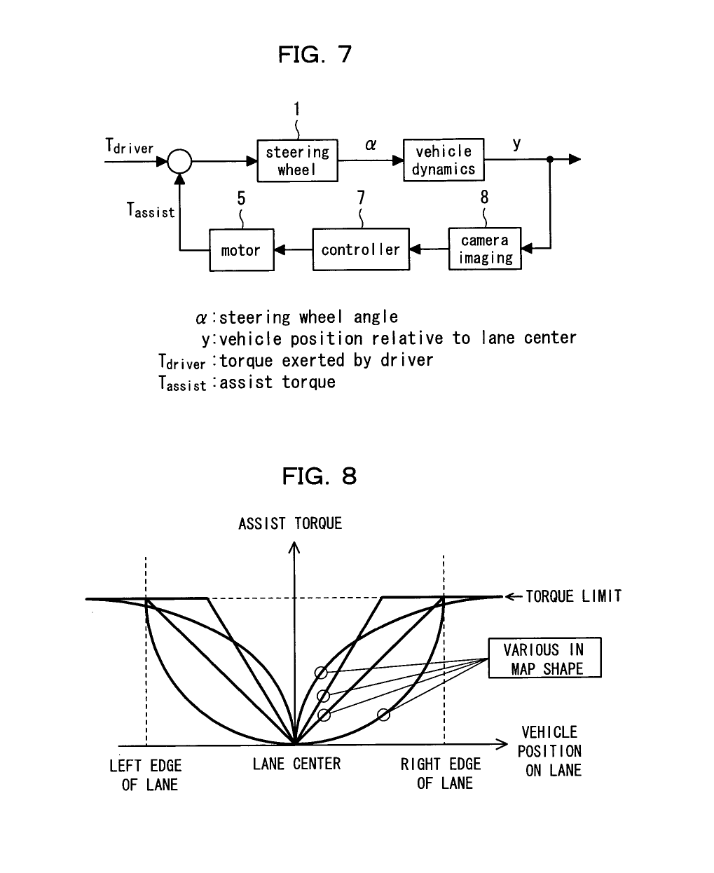

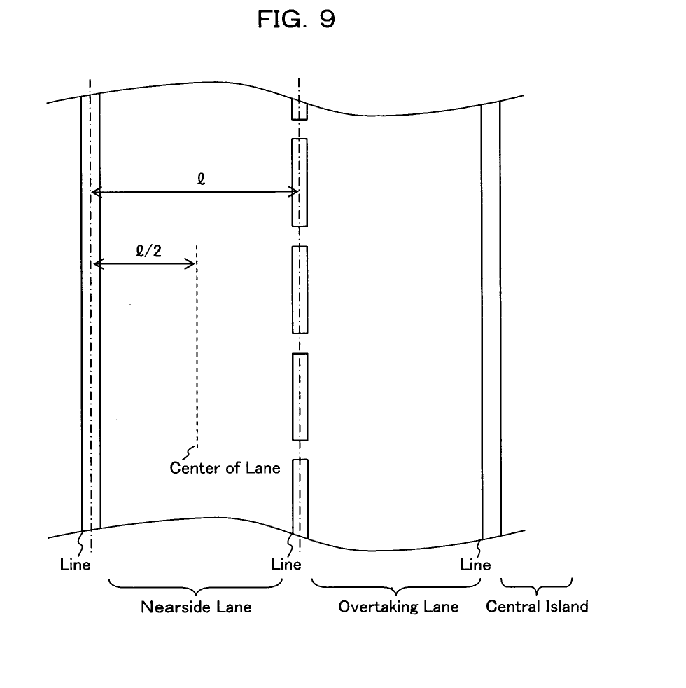

Next, overall action performed in the lane keeping assistant system of the present invention will now be described with reference to FIG. 7. The determination of an assist torque Tₐₛₛᵢₛₜ in the ECU 7 is identical to that described above, so any repetitious description will be omitted here. First of all, upon the pulse generating means 23 in the ECU 7 determines an assist torque Tₐₛₛᵢₛₜ, the ECU 7 transmits a control signal matching with the determined assist torque Tₐₛₛᵢₛₜ to the motor 5 and the motor 5 is driven. Then the sum of the driven torque (an assist torque) Tₐₛₛᵢₛₜ of the motor 5 and a steering torque T_{dirver} exerted by the driver is applied to the steering wheel 1.

Responsive to the sum torque, driver's exertion of the steering wheel 1 changes movement characteristic of the vehicle in accordance with a current steering angle α so that the lateral deviation amount (vehicle position relative to lane center) y decreases. Then the lateral deviation amount y is fed back to the ECU 7 by means of the camera 8 to be used for determination of an assist torque Tₐₛₛᵢₛₜ at a next routine.

Since the apparatus of the present invention uses an assist torque that is to be applied to the steering wheel 1, it is possible to provide the driver with vehicle position information (lateral deviation relative to the lane center) without affecting the vehicle dynamics. In other words, a high-frequency input is easily perceived by a human and can therefore certainly make the driver notice lateral deviation. At the same time at the yaw moment on the vehicle is insignificant it is advantageously possible to avoid driver's overreliance on this assistance apparatus.

If such haptic feedback control is not adopted, a relatively large driving torque is required so that a driver perceives an assist torque, and therefore the apparatus plays a role similar to an automatic driving system. As a consequence, the driver relies on the apparatus and it is problematically difficult to induce alertness on the driver. The lane keeping assistance apparatus of the present invention can solve the problems without new hardware. Especially, when the map a and map b are used , the influence give to the movement of the vehicle is effectively suppressed while the perceived stimulation by the driver is comparatively strong.

A plurality of maps is prepared in the assist torque determining means 23a and one of the maps is selected in accordance with a degree of decrease in alertness of the driver, so that it is advantageously possible to determine an assist torque suitable for the degree of decrease in the driver's alertness.

Similarly, a plurality of maps is prepared in the gain determining means 23b and one of the maps is selected in accordance with a degree of decrease in alertness of the driver, so that it is advantageously possible to determine a gain, a steering input frequency, and a time interval of pulse generation suitable for the degree of decrease in the driver's alertness.

When the torque generating means 23 determines a larger gain concerning a pulse-like assist torque or determines a shorter time interval to repeatedly generate the above pulse-like assist torque as the lateral deviation amount become larger, the driver can sense the extent of lateral deviation and an appropriate steering operation can be promoted.

If the torque generating means 23 determines the above pulse-like assist torque to be respectively generated at shorter time intervals as the vehicle is traveling at a higher speed, a time interval between assist torques generated is shorter at high speed driving, so that it is possible to make the driver to strongly recognize lane position information so that the driver can properly steer to keep the lane. Additionally, it is possible to enhance the safety of the vehicle.

Further, if the torque generating means 23 determines a larger gain concerning a pulse-like assist torque as driver's alertness measured in the alertness measuring means 21 becomes less or if less driver's alertness causes the torque generating means 23 to determine an assist torque to be generated at shorter time intervals, less driver alertness results in more powerful stimulus to the driver so that the driver can be aware of the lowering in alertness and the apparatus can provide the driver with lane position information on the basis of the current alertness.

Further, the present invention should by no means be limited to the foregoing embodiment, and various changes or modifications may be suggested without departing from the gist of the invention. For example, the illustrated example utilizes a ball-and-nut steering mechanism as shown in FIG. 2, but alternatively a rack-and-pinion steering system may be applied. An engagement mechanism that engages the motor 5 and the steering shaft 2 is a belt-driven type shown in FIG. 2; alternatively, the engagement mechanism may be a gear-driven type.

What is claimed is:

1. A lane keeping assistant apparatus comprising torque generating means for generating, on a steering wheel of a vehicle, a torque in a shape and, or frequency that does not affect the vehicle dynamics.

2. A lane keeping assistant apparatus comprising:
lane center locating means for locating the center of a lane on which a vehicle is traveling;
lateral deviation amount calculating means for calculating an amount of lateral deviation of a width center of the vehicle from the center of the lane located by said lane center locating means;
torque generating means for determining a torque that is to be applied to a steering wheel of the vehicle based on the lateral deviation amount calculated by said lateral deviation amount calculating means and for pulsewise generating the torque in a shape and, or frequency that does not affect the vehicle dynamics.

3. A lane keeping assistant apparatus according to claim 2, wherein said torque generating means determines a greater gain concerning the torque that is to be pulsewise generated as the lateral deviation amount becomes larger.

4. A lane keeping assistant apparatus according to claim 2, wherein said torque generating means repeatedly generates the torque that is to be pulsewise generated at shorter time intervals as the lateral deviation amount becomes larger.

5. A lane keeping assistant apparatus according to claim 2, wherein said torque generating means generates the torque that is to be pulsewise generated in a direction that the width center of the vehicle is closing to the center of the lane and then generates the torque that is to be pulsewise generated in a direction that the width center of the vehicle is departing from the center of the lane.

6. A lane keeping assistant apparatus according to claim 2 further comprising alertness measuring means for measuring alertness of a driver of the vehicle, wherein said torque generating means determines a greater gain concerning the torque that is to be pulsewise generated as the alertness of the driver measured by said alertness measuring means is less.

7. A lane keeping assistant apparatus according to claim 2 further comprising alertness measuring means for measuring alertness of a driver of the vehicle, wherein said torque generating means pulsewise generates the torque repeatedly at shorter time intervals as the alertness of the driver measured by said alertness measuring means becomes less.

8. A lane keeping assistant apparatus according to claim 1, wherein said torque generating means pulsewise generates the torque repeatedly at shorter time intervals as the vehicle is traveling at a higher speed.

9. lane keeping assistant apparatus according to claim 1, wherein the frequency is equal to or higher than 3 Hz.

10. A lane keeping assistant apparatus according to claim 2, wherein said torque generating means pulsewise generates the torque repeatedly at shorter time intervals as the vehicle is traveling at a higher speed.

11. lane keeping assistant apparatus according to claim 2, wherein the frequency is equal to or higher than 3 Hz.
